(19) United States
(12) Patent Application Publication
(10) Pub. No.: US 2016/0379281 A1
(43) Pub. Date: Dec. 29, 2016

(54) COMPLIANCE VIOLATION EARLY WARNING SYSTEM

(71) Applicant: Bank of America Corporation, Charlotte, NC (US)

(72) Inventors: Kasilingam Basker Laxmanan, West Chester, PA (US); Gerald Parise, Moorsetown, NJ (US); Yudong Chen, Denver, CO (US); Wei Wang, Wilmington, DE (US)

(21) Appl. No.: 14/748,450

(22) Filed: Jun. 24, 2015

(51) Int. Cl. G06Q 30/02; G06N 7/00; G06N 99/00; G06F 17/30

(52) U.S. Cl. CPC G06Q 30/0282; G06F 17/30345; G06F 17/30321; G06N 7/005; G06N 99/005

(57) ABSTRACT

Apparatus and methods for triggering a compliance violation early warning system are provided. The apparatus may include a receiver. The receiver may receive structured data and unstructured complaint data related an authenticated user. The apparatus may include a processor. The processor may classify the complaint. The processor may create a complaint classification. The classifying may analyze the frequency of each keyword, included in a plurality of keywords, in the complaint. The classifying may rank each keyword. The ranking may be based on the frequency of the keyword. The ranking may be based on the relevance of each keyword to each violation attribute, included within a plurality of violation attributes. The processor may combine the structured data with the unstructured complaint classification data to determine the likelihood of the complaint becoming a regulatory compliance issue. The processor may thereby determine when to trigger the compliance violation early warning system.

### FIELD OF TECHNOLOGY

This invention relates to early warning systems. Specifically this invention relates to compliance violation early warning systems.

### BACKGROUND OF THE DISCLOSURE

An entity may receive thousands of complaints from customers daily. These complaints may be transmitted via text messaging, online interfaces, chat rooms, phone calls, paper mail, e-mail or any other suitable method. The complaints may refer to a myriad of different subjects, from dislike of the entity logo color to legal complaints pertaining to violations of federal laws.

Conventionally, in order to prioritize complaints for allocating response resources, legal teams may comb through the complaints and retrieve a subset of relatively higher-priority complaints. This process may be lengthy, time-consuming, and not necessarily accurate.

Therefore, the need exists for a compliance-violation early warning system which may systematically analyze each complaint and determine if the complaint may pose a danger of escalating into a regulatory compliance issue. The early warning system may notify the entity that a specific complaint should be dealt with in order to avoid future regulatory compliance issues.

### SUMMARY OF THE DISCLOSURE

Apparatus and methods for triggering a compliance violation early warning system are provided. The apparatus may include a receiver. The receiver may be configured to receive structured data. The structured data may be related to an authenticated user. The receiver may be configured to receive unstructured data. The unstructured data may be complaint data. The complaint data may be related to the authenticated user.

The apparatus may also include a processor. The processor may be configured to classify the complaint. The processor may be configured to create a complaint classification. The classifying may include analyzing the frequency of each keyword, included in a plurality of keywords, that appears in the complaint. The classifying may include ranking each keyword that appears in the complaint. The ranking may be based on the frequency of the keyword included in the complaint. The ranking may be based on the relevance of each keyword to each violation attribute included within a plurality of violation attributes.

The processor may also combine the structured data with the unstructured complaint classification data to determine the likelihood of the complaint becoming a regulatory compliance issue. The processor may thereby determine when to trigger the compliance violation early warning system.

The structured data may also include behavior patterns associated with the user.

The structured data may also include account information. The account information may be associated with the user. The unstructured data may also include text verbatim from a customer complaint interaction.

### BRIEF DESCRIPTION OF THE FIGURES

The objects and advantages of the invention will be apparent upon consideration of the following detailed description, taken in conjunction with the accompanying drawings, in which like reference characters refer to like parts throughout, and in which:

FIG. 1 shows an illustrative apparatus in accordance with principles of the invention;

FIG. 2 shows an illustrative apparatus in accordance with the principles of the invention;

FIG. 3 shows an illustrative flow chart according to certain embodiments;

FIG. 4 shows an illustrative flow chart according to certain embodiments;

FIG. 5 shows an illustrative flow chart according to certain embodiments;

FIG. 6 shows an illustrative diagram according to certain embodiments;

FIG. 7A shows an illustrative diagram according to certain embodiments;

FIG. 7B shows an illustrative diagram according to certain embodiments;

FIG. 8 shows an illustrative diagram according to certain embodiments; and

FIG. 9 shows an illustrative diagram according to certain embodiments.

### DETAILED DESCRIPTION OF THE DISCLOSURE

A method for triggering or using a compliance violation early warning system is provided. The method may include receiving a first plurality of complaints. The method may include tokenizing each complaint included within the first plurality of complaints. The method may include removing non-text tokens from each complaint included within the first plurality of complaints. The method may include removing stop words from each complaint included within the first plurality of complaints. The method may include identifying remaining text tokens within each complaint. The method may include stemming each text token included in each complaint. The stemming may include identifying the root word of each text token included in each complaint.

The method may include ranking each complaint in the first plurality of complaints. The ranking may include determining the frequency of each keyword in each complaint. The keyword may be included in a pre-determined plurality of keywords. The ranking may also include ranking each keyword included in each complaint based at least in part on a group of criteria. The criteria may include a frequency of the keyword within the complaint. The criteria may also include a relevance of the keyword to each violation attribute, included within a plurality of violation attributes. The relevance may be based on a predetermined keyword relevance index. The relevance may be based on predictive keyword relevance index. The predictive keyword relevance index may be dynamic.

The method may include selecting a second plurality of complaints from the first plurality of complaints based on the ranking. The method may include triggering a compliance violation early warning system for each complaint included in the second plurality of complaints.

Each complaint included in the second plurality of complaints may be ranked relatively higher than the complaints included in the first plurality of complaints.

The method may also include implementing machine-learning algorithms. The machine-learning algorithms may determine which keywords are relatively more useful in defining complaints that are high ranking. The machine-learning algorithms may also alter the keyword relevance index based on the determination.

The violation attributes may also include a potential violation relating to Unfair, Deceptive, or Abusive Acts and Practices (UDAAP); Fair Debt Collection Practices Act (FDCPA); European Fair Trade Association (EFTA); Servicemembers Civil Relief Act (SCRA); Fair Credit Reporting Act (FCRA); Fair Lending; Equal Credit Opportunity Act (ECOA); Federal Housing Administration (FHA); Home Mortgage Disclosure Act (HMDA); Truth in Lending Act (TILA); Truth in Savings Act (TISA), Consumer Financial Protection Bureau Regulations; Financial industry regulatory authority (FINRA); Community Reinvestment Act (CRA); Expedited Funds Availability Act (EFAA); Flood Disaster Protection Act (FDPA); Telephone Consumer Protection Act (TCPA) and/or Real Estate Settlement Procedures Act (RESPA).

A relatively high ranking may be determined with respect to a certain compliance violation. The ranking may also be a combination of ranking of several possible compliance violations.

The stemming may include utilizing a library of financial industry terms to identify the root word of each text token.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

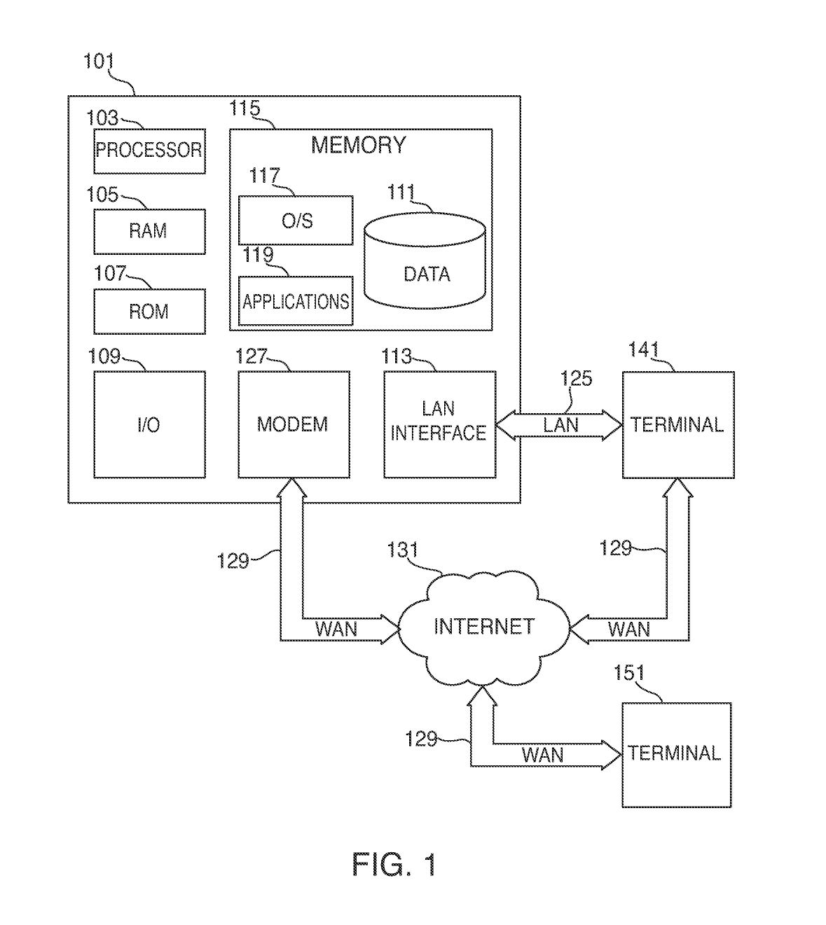

FIG. 1 is an illustrative block diagram of system 100 based on a computer 101. The computer 101 may have a processor 103 for controlling the operation of the device and its associated components, and may include RAM 105, ROM 107, input/output module 109, and a memory 115. The processor 103 will also execute all software running on the computer—e.g., the operating system. Other components commonly used for computers such as EEPROM or Flash memory or any other suitable components may also be part of the computer 101.

The memory 115 may be comprised of any suitable permanent storage technology—e.g., a hard drive. The memory 115 stores software including the operating system 117 any application(s) 119 along with any data 111 needed for the operation of the system 100. Alternatively, some or all of computer executable instructions may be embodied in hardware or firmware (not shown). The computer 101 executes the instructions embodied by the software to perform various functions.

Input/output (“I/O”) module may include connectivity to a microphone, keyboard, touch screen, and/or stylus through which a user of computer 101 may provide input, and may also include one or more speakers for providing audio output and a video display device for providing textual, audiovisual and/or graphical output.

System 100 may be connected to other systems via a LAN interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program(s) 119, which may be used by computer 101, may include computer executable instructions for invoking user functionality related to communication, such as email, Short Message Service (SMS), and voice input and speech recognition applications.

Computer 101 and/or terminals 141 or 151 may also be devices including various other components, such as a battery, speaker, and antennas (not shown).

Terminal 151 and/or terminal 141 may be portable devices such as a laptop, cell phone, Blackberry™, smartphone or any other suitable device for storing, transmitting and/or transporting relevant information. Terminals 151 and/or terminal 141 may be other devices. These devices may be identical to system 100 or different. The differences may be related to hardware components and/or software components.

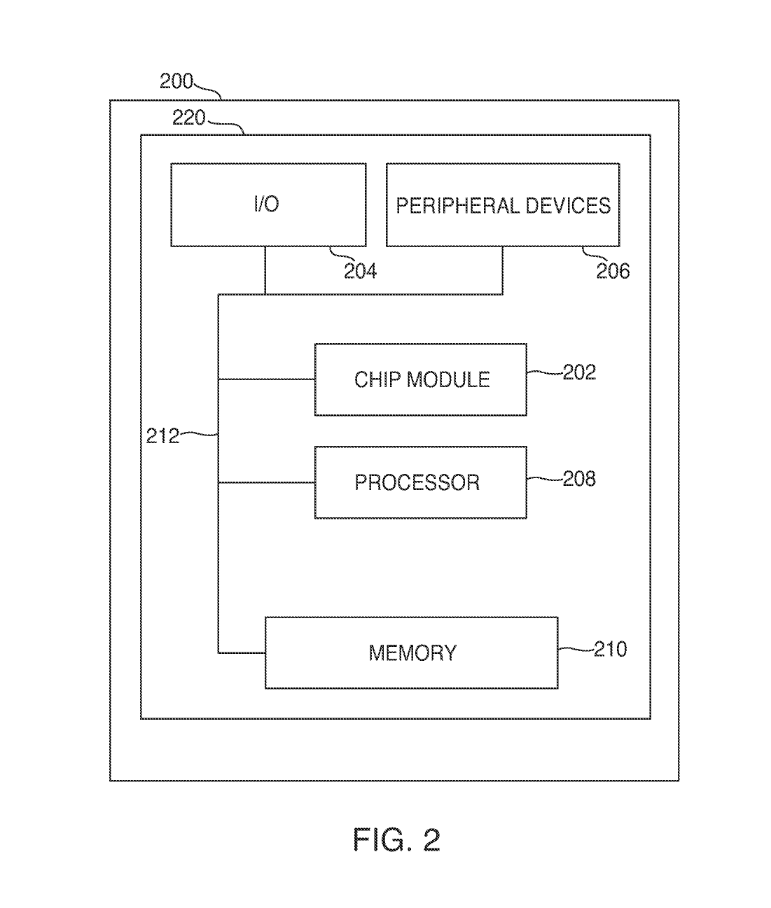

FIG. 2 shows illustrative apparatus 200. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device 208, which may compute data structural information, structural parameters of the data, predict probable regulatory compliance violation listings and machine-readable memory 210.

Machine-readable memory 210 may be configured to store in machine-readable data structures: information pertaining to a user, information pertaining to regulatory compliance laws, the current time, information pertaining to regulatory compliance violations, information pertaining to inputters of customer complaint text verbatims, information pertaining to customer complaint text verbatims, information pertaining to customer behavior and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

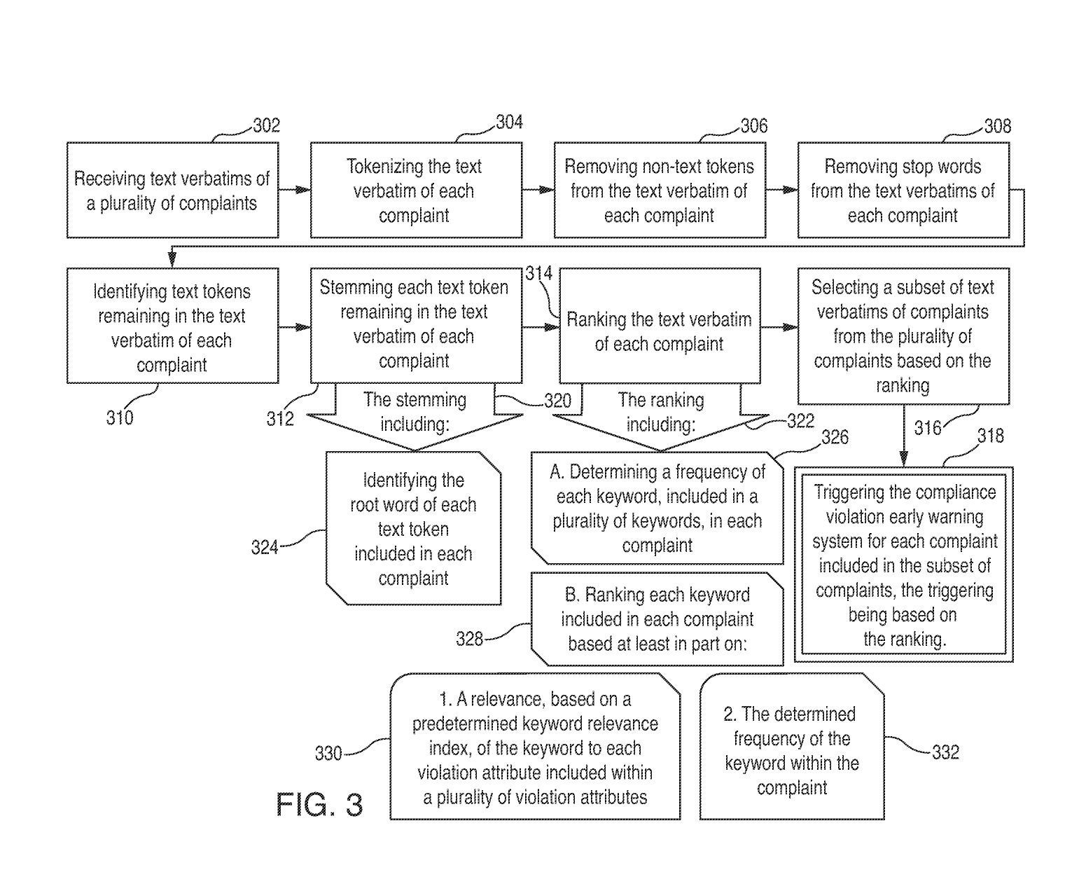

FIG. 3 shows an illustrative flow chart. Step 302 shows receiving text verbatims of a plurality of complaints. The receiving may occur at a processing station. The receiving may occur at a computer or mainframe. The complaints may have been submitted via paper slips. The complaints may have been submitted electronically, via text messaging, e-mail, chat messaging or any other suitable electronic submission.

Step 304 shows tokenizing the text verbatim of each complaint. Tokenizing may include breaking down a sentence structure into components. This may include removing whitespace, hyphens and/or other separators. Tokenizing a text verbatim may produce a list or array of tokens. The list or array of tokens may include the words included in the text verbatim.

Step 306 shows removing non-text tokens from the text verbatim of each complaint. A processor may determine which tokens are non-text tokens—i.e., punctuation marks, grammatical annotations, etc. The processor may remove the non-text tokens from the list or array produced by Step 304.

Step 308 shows removing stop words from the text verbatim of each complaint. The processor may loop through the array or list to determine if any of the words are stop words. Stop words are grammatical words which enable a user to understand a sentence but do not add substance to the sentence. The words “a”, “the”, and/or “for” may be included in a list of stop words.

Step 310 shows identifying text tokens remaining in the text verbatim of each complaint. Step 312 shows stemming each text token included in the text verbatim of each complaint. Arrow 320 shows stemming may include step 324. Step 324 shows identifying the root word of each text token included in each complaint. For example, the word “maintenance” may be stemmed to the root word “maintain”. Stemming may utilize a vocabulary or library specific to the banking or financial industry or any other suitable source.

Step 314 shows ranking the text verbatim of each complaint. Arrow 322 shows the ranking may include steps 326, 328, 330 and 332. The ranking may include identification of a plurality of keywords. The plurality of keywords may be included in a keyword library or keyword listing. Step 326, which may include a first step of the ranking, shows determining a frequency of each keyword in each complaint. For example, if a text verbatim of a complaint included the “word” or the “stemmed root” “maintain” three times, the processor may calculate that the frequency of the word maintain is three.

Step 328, which may include a second step of the ranking, shows ranking each keyword included in each complaint based at least in part on steps 330 and 332.

Step 330 shows a determined relevance for use with ranking. The determined relevance may be based on a predetermined keyword relevance index value which represents the relevance of the keyword to each violation attribute. Each violation attribute may be selected from a plurality of violation attributes. Step 332 shows a determined frequency of the keyword within the complaint. The determined frequency may also be used either by itself or together with relevance determination 332 as a basis for the ranking.

Step 316 shows selecting a subset of text verbatims of complaints from the plurality of complaints based on the ranking. The subset may include complaints that are related to compliance violations and therefore may have a relatively higher likelihood of causing regulatory issues.

Step 318 shows triggering a compliance violation early warning system for each complaint included in the subset of complaints. The early warning system may alert personnel of the entity receiving the complaints. The personnel may handle each complaint included in the subset of complaints to ensure that the entity complied with relevant regulations. The personnel may also ensure that the customer associated with each complaint may, preferably timely, receive sufficient compensation, and therefore, not escalate the complaint to a legal issue.

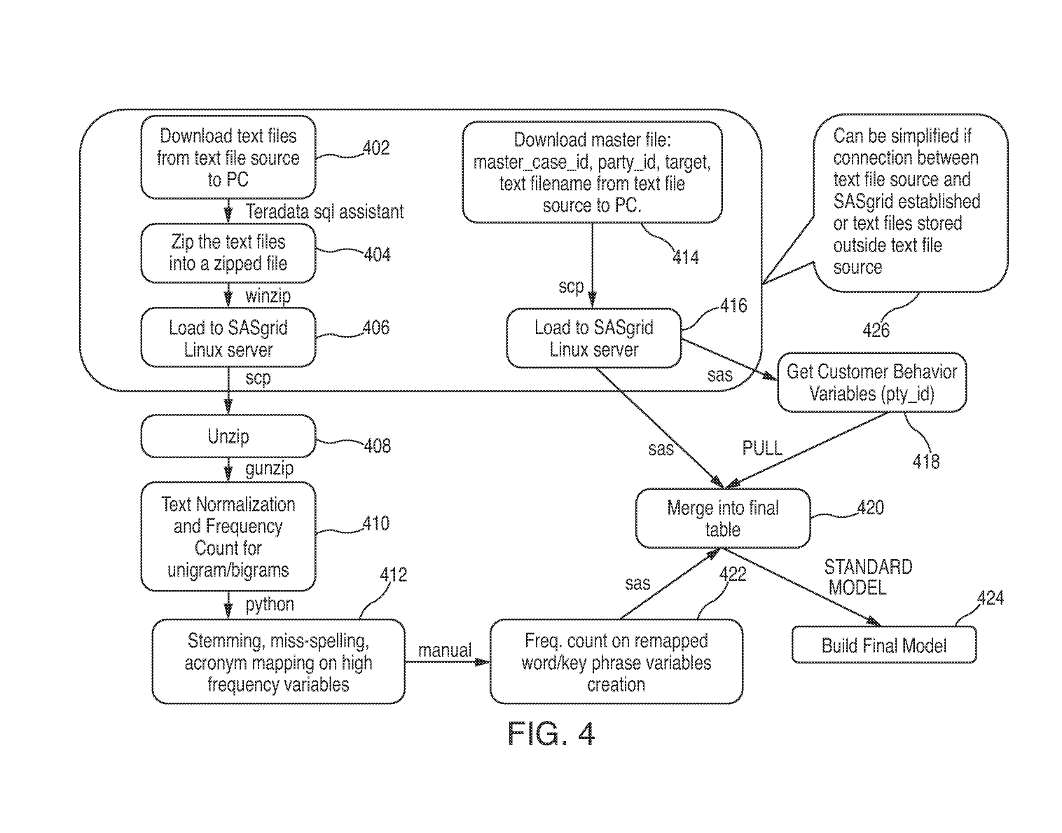

FIG. 4 shows an illustrative flow chart of information flow. Step 402 shows downloading text files from text file source to PC, or personal computer. The text files may include text verbatims of complaints. Step 402 may utilize Teradata SQL Assistance. Teradata SQL Assistant, or TSA is an Open DataBase Connectivity (“ODBC”) based client utility used to access and manipulate data on ODBC-compliant database servers.

Step 404 shows zipping the text files into at least one zipped file. The zipping may be executed by a Winzip application. WinZip is a shareware file archiver and compressor for Windows, OS, X, iOS and Android. WinZip was developed by WinZip Computing having headquarters in Mansfield, Conn., USA. WinZip can create archives in Zip file format, and unpack some other archive file formats.

Step 406 shows loading the text files to an SASgrid which may utilize a Linux server. SASgrid is a secure, networked environment that allows for coordinated sharing of heterogeneous computing resources. SASgrid computing enables users to develop a controlled, shared environment that is dedicated to high speed processing of large volumes of data and analytic programs. SASgrid uses dynamic, resource-based load balancing. The loading may be done by SCP. Secure copy, or SCP, may be a means of securely transferring computer files between a local host and a remote host or between two remote hosts. SCP may be based on the Secure Shell (“SSH”) protocol.

Step 408 shows unzipping the text files. The unzipping may be executed by Gunzip. Gunzip may be a command used to decompress files.

Step 410 shows text normalization and frequency count for unigrams and/or bigrams. Step 402 may normalize the text verbatims included in the complaints. In this context, normalizing may be understood to refer to stemming of the text verbatims.

The process may also count the frequency of unigrams, bigrams and/or trigrams included in each complaint. A unigram may be a single word. Bigrams may be a word pair with the habitual juxtaposition of a particular word with another word with a frequency greater than chance. Trigrams may be three words which are a collocation.

The text normalization and frequency count may be executed by Python code. Python is a widely-used, general-purpose, high level programming language.

Step 412 shows stemming, misspelling, and/or acronym mapping on variables, or text tokens, which may occur frequently in the complaints. Step 412 may be done manually. In step 422, there may be a re-calculation of the frequency count on the remapped keywords or phrase variables.

Step 414 shows downloading a master file from the text file source to a PC. The master file may include a master case ID, a party ID and/or a text file name. The downloading may be executed by SCP.

Step 416 shows loading the text files to SASgrid. SASgrid is a secure, networked environment that allows for coordinated sharing of heterogeneous computing resources. SASgrid computing enables users to develop a controlled, shared environment that is dedicated to high speed processing of large volumes of data and analytic programs. SASgrid uses dynamic, resource-based load balancing. The loading may be executed by a SAS program. The SASgrid may utilize a server. The server may be Linux-based. Linux is an open source operating system.

Step 418 shows obtaining information relating to customer behavior variables. Customer behavior variables may include information pertaining to prior customer behavior. The information may include text verbatims of complaints a customer has previously submitted. The information may include address information of the customer. The customer behavior variables may be transferred, utilizing a pull method, to Step 420.

In Step 420, the customer behavior variables may be merged with the text files and the frequency count of the remapped keywords to produce a final table, utilizing SAS and/or a pull method. Step 424 shows build of the final model utilizing a standard model.

Step 426 shows that steps 402, 404, 406, 414 and 416 may be simplified if a connection between the text file source and SASgrid is established or if the text files are stored outside of the text file source.

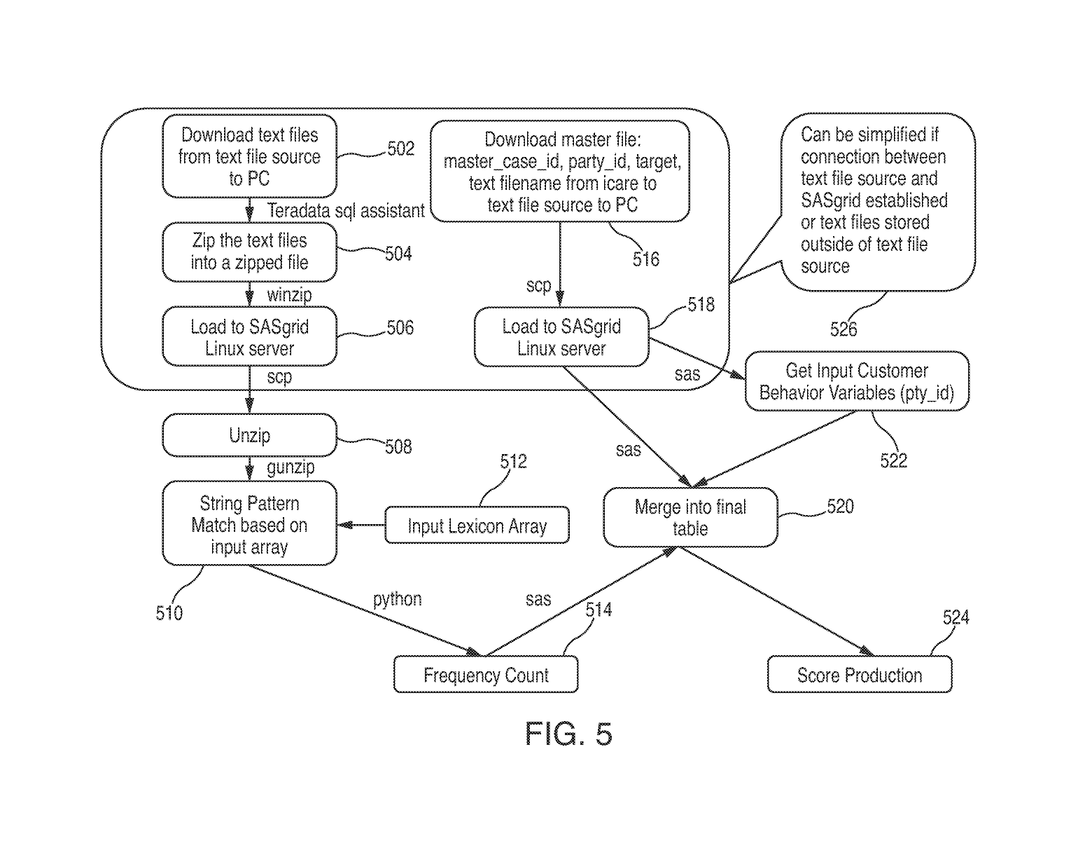

FIG. 5 shows an illustrative flow chart of data transfer and manipulation. Step 502 shows downloading a text files from text file source to PC. The text files may include text verbatims of complaints. Step 502 may utilize Teradata SQL Assistance.

Step 504 shows zipping the text files into a zipped file. The zipping may be executed by a Winzip application.

Step 506 shows loading the text files to the SASgrid which may utilize a Linux server. The loading may be done by SCP.

Step 508 shows unzipping the text files. The unzipping may be executed by Gunzip.

Step 512 shows inputting of a lexicon array into step 510. The lexicon array may include a wordlist which is associated with the banking or financial industry or other suitable industry.

Step 510 shows identifying strings and patterns in the text verbatims which are associated with the inputted word list. The identified strings and patterns may match strings and/or patterns included in the lexicon array.

Utilizing Python, or any other suitable computing language, step 514 shows determining the frequency of the strings and/or word patterns which match the strings and/or word patterns included in the lexicon array. The frequency count may be transferred for use in step 520.

Step 516 shows downloading a master file from the text file source to a PC. The master file may include a master case ID, a party ID and/or a text file name. The downloading may be executed by SCP.

Step 518 shows loading the text files to SASgrid. The loading may be executed by a SAS program. The SASgrid may utilize a server. The server may be Linux-based.

Step 522 shows obtaining customer behavior variables. Customer behavior variables information may include information pertaining to prior customer behavior. The information may include text verbatims of complaints a customer has previously submitted. The information may include address information of the customer. The customer behavior variables may be transferred, using any suitable hardware and/or software, to Step 520.

In Step 520, the customer behavior variables may be merged, utilizing SAS and/or any other suitable method, with the master file as loaded onto the SASgrid and with the frequency count of the strings and/or patterns to produce a final table. Step 524 shows the production of a score for a text verbatim of a complaint. Step 524 may be executed using any suitable software and/or hardware.

Step 526 shows that steps 502, 504, 506, 516 and 518 may be simplified if a connection between the text file source and SASgrid is established or if the text files are stored outside of the text file source.

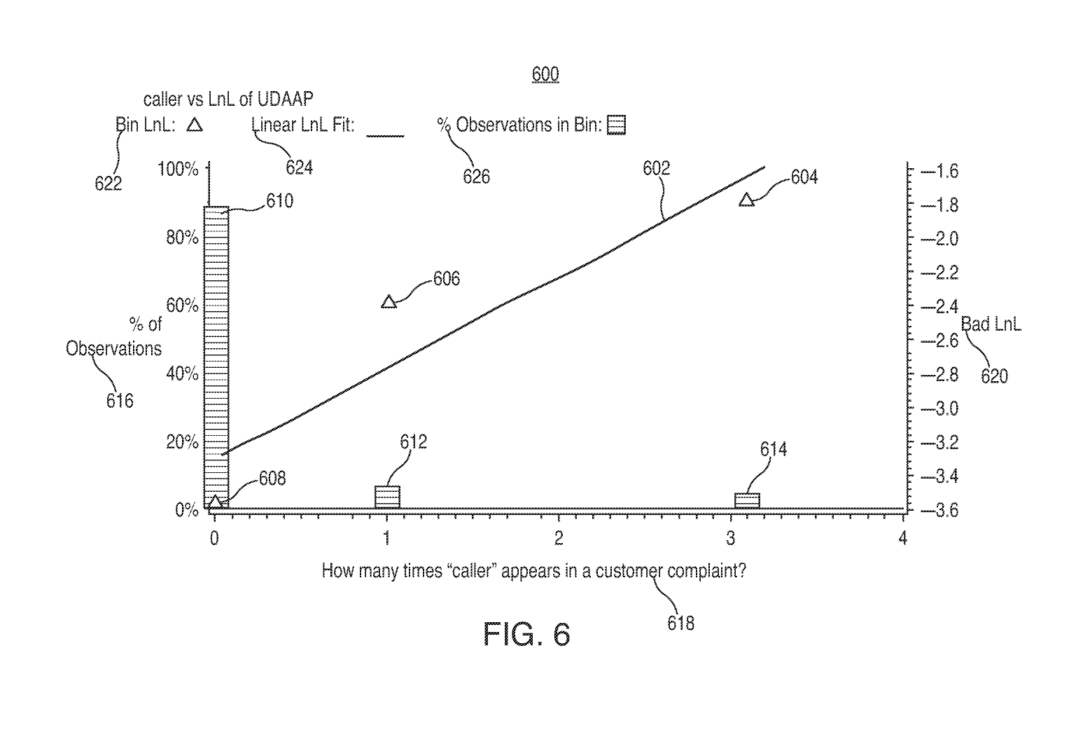

FIG. 6 shows illustrative graph 600. Graph 600 is titled “Caller vs. LnL of UDAAP”. LnL represents longitude-latitude. UDAAP represents Unfair, Deceptive, or Abusive Acts and Practices. Graph 600 includes information relating to a frequency. The frequency may be how many times the word “caller” appears in a customer complaint. The frequency may also be how likely the customer complaint will cause a regulatory issue. The frequency may also be a combination of how many times the word “caller” appears in a customer complaint and how likely the customer complaint will cause a regulatory issue. The regulatory issue may be with regard to a UDAAP violation. It should be appreciated that although graph 600 refers to the unigram, “caller”, and a UDAAP violation, the graph may utilized to calculate many different unigrams, bigrams and trigrams, with respect to many different violations.

The key of graph 600 may show that a triangle symbol may refer to a Bin LnL, as shown at 622. A Bin may refer to a group. An LnL may refer to a longitude-latitude. A Bin LnL may refer to a group related to a longitude-latitude. The key of graph 600 may also show that a line may refer to a linear LnL Fit, as shown at 624. The line may refer to a linear trend in the plotting of the triangular symbols. The key of graph 600 may also show that the percentage of observations in bin may be indicated by a shaded bar. The percentage of observations in Bin may be the percentage of customer complaint text verbatims which include a specific frequency of a unigram and caused a regulatory compliance issue with respect to a specific regulatory issue.

The “percentage of observations” is shown at 616. “How many times “caller” appears in a customer complaint?” is shown at 618. Bad LnL is shown at 620. Bad LnL may be the statistical correlation of a point on the graph to a group of “bads”, using the graphical longitude latitude. The group of “bads” may be a collection of text verbatims that caused regulatory compliance violations.

Triangle symbol 608, plotted, may indicate that in zero percent of a plurality of customer complaint text verbatims which included the unigram “caller” zero times, the customer complaint text verbatim was related to a UDAAP violation. Triangle symbol 606, plotted, may indicate that in 62 percent of a plurality of customer complaint text verbatims which included the unigram “caller” one time, the customer complaint text verbatim was related to a UDAAP violation. Triangle symbol 604, plotted, may indicate, that in 92 percent of a plurality of customer complaint text verbatims which included the unigram “caller” three times, the customer complaint text verbatim was related to a UDAAP violation.

Block 610 shows that 88 percent of the plurality of customer complaint text verbatims included the unigram “caller” zero times. Block 612 shows that seven percent of the plurality of customer complaint text verbatims included the unigram “caller” one time. Block 614 shows that five percent of the plurality of customer complaint text verbatims included the unigram “caller” three times.

Trend line 602 shows the trend of the correlation of the unigram “caller” frequency to a UDAAP violation.

Bad LnL 620 shows statistical correlation of the longitude latitude of the plurality of text verbatims with a group of “bads”. The group of “bads” may be a group of text verbatims which caused a regulatory compliance violation.

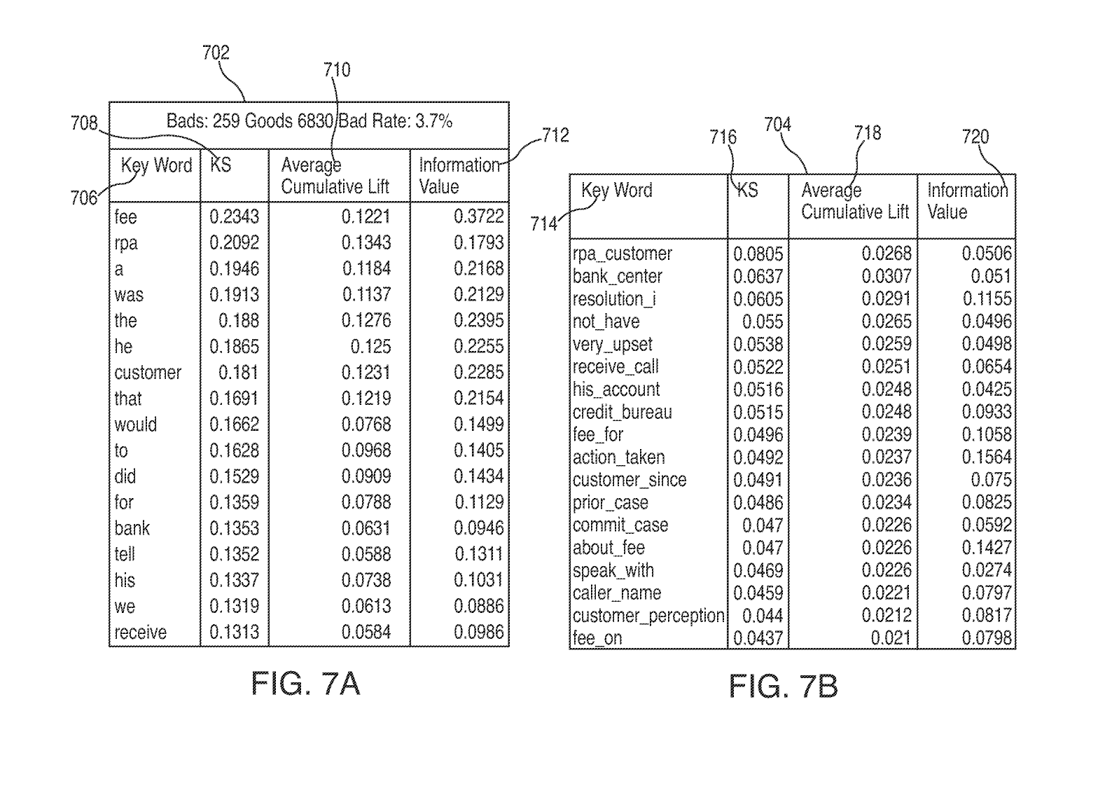

FIG. 7A shows a list of keyword unigrams. FIG. 7A shows how closely the unigram is related to a potential regulatory issue. List 702 includes column 706. Column 706 includes a list of unigram keywords which, when included in a customer complaint text verbatim, may be related to a potential regulatory violation.

Mainframe computers, or any other suitable computer machinery, utilizing machine-learning algorithms, may identify millions of inputted customer complaint text verbatims. After stemming the complaint, the machine learning algorithm may receive input as to whether the complaint caused a regulatory issue. If the complaint caused a regulatory issue, the input may include identification of the regulatory issue. The machine-learning algorithms may utilize the inputted information to determine whether the keywords included in the complaints are related to regulatory issues or not.

The machine-learning algorithms may utilize the Kolmogorov-Smirnov (“KS”) test, as indicated in column 708. The KS test may determine whether the keyword is within a normal distribution range—i.e., not more likely to cause a specific regulatory issue. The closer the KS value is to one, the more likely the keyword, when included in a customer complaint text verbatim, may cause a regulatory issue.

The machine-learning algorithms may also utilize an Average Cumulative Lift test, as indicated in column 710. The Average Cumulative Lift test may determine whether the keyword is within a normal range.

The machine-learning algorithms may also utilize an Information Value test, as indicated in column 712. Information Value may assesses the overall predictive power of the variable being considered, and therefore can be used for comparing the predictive power among competing variables. Information Value may be calculated utilizing Formula A.

$$Formula A$$

$$IV = {\sum }_{n = 1}^{∞} ( \begin{matrix}( \% {ViolationKeyword}_{i} - \% {nonViolationKeyword}_{i} ) \times \\ ln ( \frac{ \% {ViolationKeyword}_{i}}{\% {nonViolationKeyword}_{i}} )\end{matrix} )$$

Variables of similar natures usually behave similarly and have very high correlation with each other. Columns 712 and 720 of FIGS. 7A and 7B refer to Information Value. The data in columns 712 and 720 may show how the variables cluster together. In FIG. 7A, the keyword “to” offers a very similar Information Value as the keyword “did”. As a regression prefers variables of lower dependence from one another, only one variable from each cluster needs to be chosen to enter the regression.

In certain embodiments, variables with extremely high Information Values may invite suspicion. A rule is provided, as Table A, for approaching variables based on their Information Value:

TABLE A
Information Value:

| | |
|---|---|
| <0.02 | un-predictive |
| 0.02 to 0.1 | weak |
| 0.1 to 0.3 | medium |
| 0.3 to 0.5 | strong |
| >0.5 | suspicious |

In column 706, the unigram “fee” has an Information Value of 0.3722, indicated in column 712, which may mean customer complaint text verbatims which include the unigram “fee” are more likely to become regulatory compliance issues.

Table 702 also shows an amount of bads, 259. Table 702 also shows an amount of goods 6830. This may be understood to mean that in a group, or bin of 7089 keywords, 259 keywords, included in the bads group, may be associated with regulatory compliance issues with respect to a UDAAP violation. The remaining 6830 may not be associated with regulatory compliance issues with respect to a UDAAP violation. The Bad Rate may be 3.7%; this may mean that 3.7% of the bin of keywords may cause regulatory compliance violation issues.

FIG. 7B shows list 704. List 704 may include information pertaining to bigrams. Bigrams may be word pairs, or collocations of two words.

FIG. 7B may include column 714, which includes a list of bigram keywords. Column 716 includes the KS value for each of the bigrams included in column 714. Column 718 includes the Average Cumulative Lift values for each of the bigrams included in column 714. Column 720 includes the Information Value for each of the bigrams includes in column 714.

The keywords may be sorted using many different means. The sorting means may include the variable name, the average lift, chi-square probability, information value, KS statistic and/or any other suitable means or probability metric.

A chi-square test may also be utilized to assess the data. A chi-square test of independence is used to determine if two variables are related. The chi-square test may determine whether a keyword is related to a specific regulatory compliance issue.

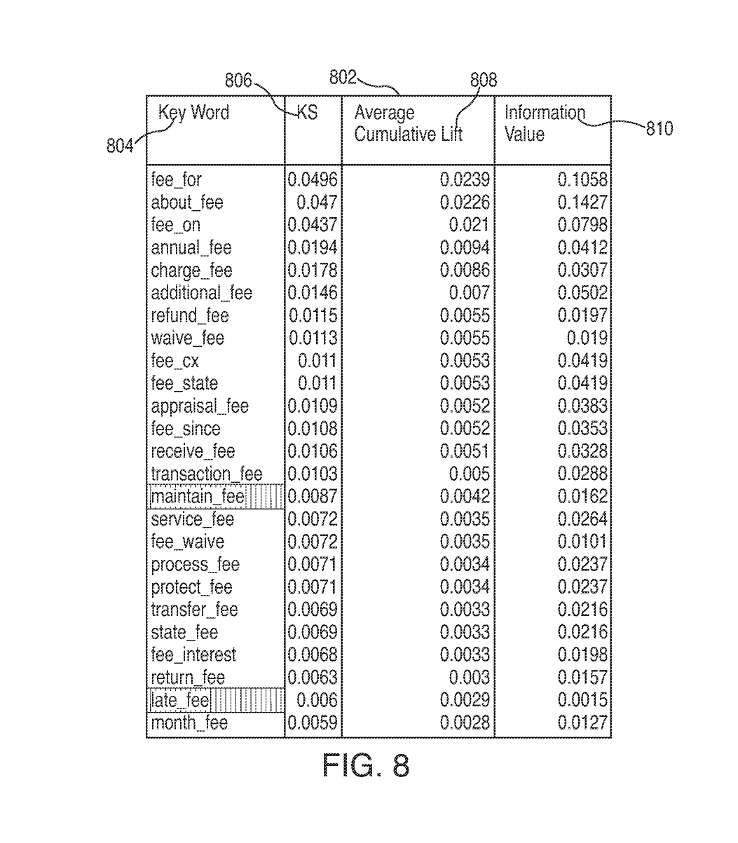

FIG. 8 shows list 802. List 802 may include keywords which may be related to a UDAAP regulatory compliance issue. List 802 includes keyword bigrams, included in column 804. List 802 also includes a KS statistic for each bigram, included as column 806. List 802 also includes an average cumulative lift for each bigram, included as column 808. List 802 also includes an information value for each bigram, included as column 810.

Conventionally, a legal team of an entity would determine which keywords, included in a customer complaint interaction, are most likely to be associated with a customer complaint text verbatim. With regard to UDAAP violations, a legal team may have defined the bigrams “maintain_fee” and “late_fee” to have the highest likelihood of association with a UDAAP violation. Using the machine learning algorithms, the compliance violation early warning system may have determined, as shown in column 804, that the bigrams “maintain_fee” and “late_fee” may not have the highest likelihood of association with a UDAAP violation. Rather, the bigrams, “fee_for” and “about_fee” may have the highest likelihood of association with a UDAAP violation.

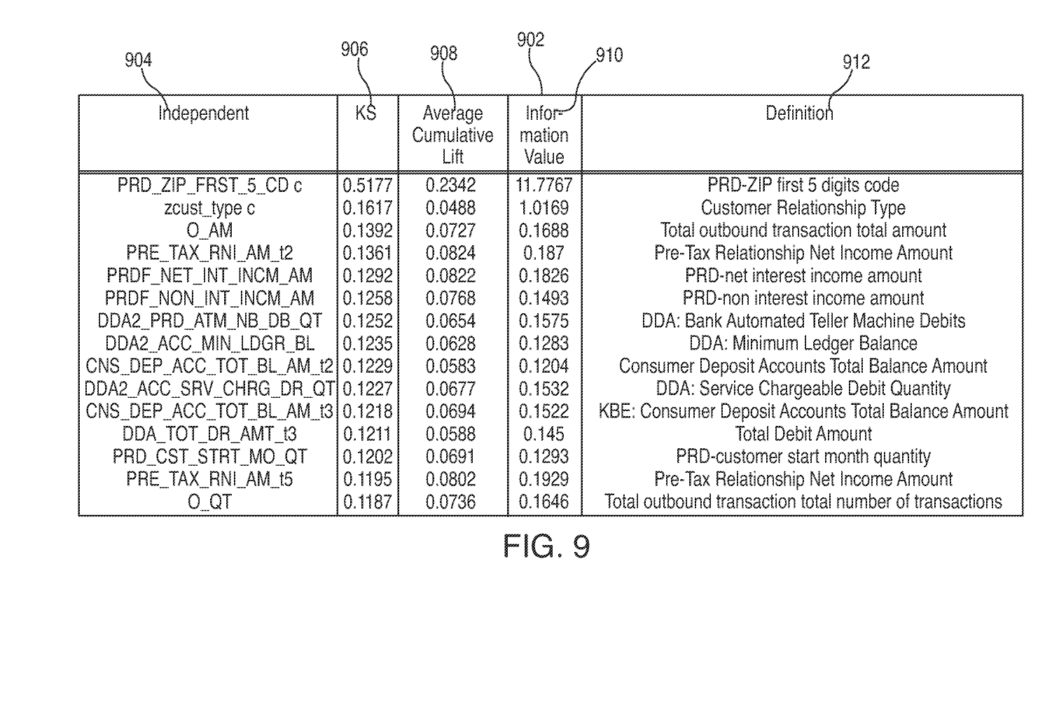

FIG. 9 shows list 902. List 902 may include independent attributes, as shown in column 904. Independent attributes may include information pertaining to a particular customer behavior. Customer behavior information may be helpful in determining which complaints may cause regulatory compliance violation issues. Each independent attribute may be rated using the KS test, as shown in column 906. Each independent attribute may be rated using an average cumulative lift, as shown in column 908. Each independent attribute may be information value, as shown in column 910. The definition of each independent attribute may be shown in column 912.

A preferred zip code (PRD-ZIP) may be an attribute which determines whether a customer is likely to cause a regulatory compliance violation issue. A list of preferred zip codes may be included in the compliance violation early warning system. The preferred zip code list may be dynamic. The list may change depending on the changing behavior of residents of a predetermined zip code.

Other attributes may include a customer relationship type, a total outbound transaction amount, a pre-tax relationship net income amount, a preferred net interest income amount, a preferred non-interest income amount, DDA (direct deposit account) bank automated teller machine debits, a DDA minimum ledger balance, a consumer deposit accounts total balance amount, a DDA service chargeable debit quantity, a Key Business Element (“KBE”) consumer deposit accounts total balance amount, a total debit amount, a preferred customer start month quantity, a pre-tax relationship net income amount, a total outbound transaction total number of transactions and for any suitable attribute.

Thus, methods and apparatus for triggering a compliance violation early warning system are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for triggering a compliance violation early warning system, the method comprising:
receiving a first plurality of complaints;
tokenizing each complaint included within the first plurality of complaints;
removing non-text tokens from each complaint included within the first plurality of complaints;
removing stop words from each complaint included within the first plurality of complaints;
identifying text tokens remaining in each complaint in the first plurality of complaints;
stemming each text token included in each complaint, the stemming comprising identifying the root word of each text token included in each complaint;
ranking each complaint in the first plurality of complaints, the ranking comprising:
determining a frequency of each keyword, included in a plurality of keywords, in each complaint;
ranking each keyword included in each complaint based at least in part on:
the determined frequency of the keyword within the complaint; and
a relevance of the keyword to each violation attribute included within a plurality of violation attributes, the relevance based on a predetermined keyword relevance index;
selecting a second plurality of complaints from among the first plurality of complaints based on the ranking; and
triggering the compliance violation early warning system for each complaint included in the second plurality of complaints.

2. The method of claim 1, wherein each complaint included in the second plurality of complaints is ranked relatively higher than the complaints included in the first plurality of complaints.

3. The method of claim 1, further comprising implementing machine learning algorithms, wherein the machine-learning algorithms rank keywords over time with respect to the ability of the keywords to characterize complaints and altering the keyword relevance index based thereupon.

4. The method of claim 3, wherein the violation attributes include a potential violation relating to at least one of:
Unfair, Deceptive, or Abusive Acts and Practices (UDAAP);
Fair Debt Collection Practices Act (FDCPA);
European Fair Trade Association (EFTA);
Servicemembers Civil Relief Act (SCRA);
Fair Credit Reporting Act (FCRA);
Fair Lending Act;
Equal Credit Opportunity Act (ECOA);
Federal Housing Administration (FHA); and
Home Mortgage Disclosure Act (HMDA).

5. The method of claim 3, wherein the ranking is with respect to a preselected compliance violation.

6. The method of claim 1, wherein the stemming comprises utilizing a library of financial industry terms to identify the root word of each text token.

7. An apparatus for triggering a compliance violation early warning system, the apparatus comprising:
a receiver configured to receive:
structured data relating to an authenticated user;
unstructured data relating to a complaint from the authenticated user;
a processor configured to classify the complaint and thereby create a complaint classification, the classifying comprising:
analyzing the frequency of each keyword, included in a plurality of keywords, in the complaint;
ranking each keyword based on:
the frequency of the keyword included in the complaint; and
the relevance of each keyword to each violation attribute, included within a plurality of violation attributes; and
the processor configured to combine the structured data with the unstructured complaint classification data to determine the likelihood of the complaint becoming a regulatory compliance issue, and, thereby, determine when to trigger the compliance violation early warning system.

8. The apparatus of claim 7, wherein the structured data further includes behavior patterns associated with the user.

9. The apparatus of claim 7, wherein the structured data further includes account information associated with the user.

10. The apparatus of claim 7, wherein the unstructured data includes text verbatim from a customer complaint interaction.

11. A method for triggering a compliance violation early warning system, the method comprising:
tokenizing each complaint included within a first plurality of complaints;
removing non-text tokens from each complaint included within the first plurality of complaints;
removing stop words from each complaint included within the first plurality of complaints;
identifying text tokens remaining in each complaint in the first plurality of complaints;
stemming each text token included in each complaint, the stemming comprising identifying the root word of each text token included in each complaint;
ranking each complaint in the first plurality of complaints, the ranking comprising:
determining a frequency of each keyword, included in a plurality of keywords, in each complaint;
ranking each keyword included in each complaint based at least in part on:
the determined frequency of the keyword within the complaint; and
a relevance of the keyword to each violation attribute included within a plurality of violation attributes, the relevance based on a predictive keyword relevance index;
selecting a second plurality of complaints from among the first plurality of complaints based on the ranking; and
triggering the compliance violation early warning system for each complaint included in the second plurality of complaints.

12. The method of claim 11, wherein each complaint included in the second plurality of complaints is ranked relatively higher than the complaints included in the first plurality of complaints.

13. The method of claim 11, further comprising implementing machine-learning algorithms, wherein the machine-learning algorithms rank keywords over time with respect to the ability of the keywords to characterize complaints and altering the keyword relevance index based thereupon.

14. The method of claim 13, wherein the violation attributes include a potential violation relating to at least one of:
Unfair, Deceptive, or Abusive Acts and Practices (UDAAP);
Fair Debt Collection Practices Act (FDCPA);
European Fair Trade Association (EFTA);
Servicemembers Civil Relief Act (SCRA);
Fair Credit Reporting Act (FCRA);
Fair Lending;
Equal Credit Opportunity Act (ECOA);
Federal Housing Administration (FHA); and
Home Mortgage Disclosure Act (HMDA).

15. The method of claim 13, wherein the ranking is with respect to a preselected compliance violation.

16. The method of claim 11, wherein the stemming comprises utilizing a library of financial industry terms to identify the root word of each text token.

17. The method of claim 11, wherein the predictive keyword relevance index is dynamic.
